(19) United States
(12) Patent Application Publication
(10) Pub. No.: US 2025/0379601 A1
(43) Pub. Date: Dec. 11, 2025

(54) Filtering Spurious Signals in a Wireless Transceiver

(71) Applicant: Apple Inc., Cupertino, CA (US)

(72) Inventors: Nitesh Singhal, Santa Clara, CA (US); Hongrui Wang, San Jose, CA (US); Abbas Komijani, Mountain View, CA (US); Tarek Khedr Abdalla Mealy, San Diego, CA (US)

(21) Appl. No.: 18/735,042

(22) Filed: Jun. 5, 2024

(51) Int. Cl. H04B 1/00; H02J 50/12; H04B 1/04

(52) U.S. Cl. CPC H04B 1/0078; H02J 50/12; H04B 1/0458

(57) ABSTRACT

An electronic device may include wireless circuitry having a transformer with a primary coil and a secondary coil, a first series inductor coupled to the primary coil, a second series inductor coupled to the primary coil, and a filter inductor inductively coupled to the first and second series inductors and operable to produce a first filter response when the wireless circuitry is operable in a first mode and a second filter response when the wireless circuitry is operable in a second mode. The transformer can be coupled to another filter inductor. The transformer can be coupled to an active circuit. The active circuit can include input transistors and cascode transistors. The cascode transistors can be coupled to resistors and/or capacitors that are selectively activated using associated filter switches.

### FIELD

This disclosure relates generally to electronic devices, including electronic devices with wireless communications circuitry.

### BACKGROUND

Electronic devices are often provided with wireless communications capabilities. An electronic device with wireless communications capabilities has wireless communications circuitry with one or more antennas that are used to transmit radio-frequency signals and receive radio-frequency signals.

The wireless communications circuitry can include a transceiver having one or more mixers. A mixer in the transmit path can be used to modulate signals from a baseband frequency to a radio frequency, whereas a mixer in the receive path can be used to demodulate signals from the radio-frequency to the baseband frequency. Mixers receive clock signals generated from local oscillator circuitry. It can be challenging to design satisfactory mixers and local oscillator circuitry for an electronic device.

### SUMMARY

An aspect of the disclosure provides wireless circuitry that includes a transformer having a primary coil and a secondary coil, a first series inductor coupled between the mixer and a first terminal of the primary coil, a second series inductor coupled between the mixer and a second terminal of the primary coil, and a filter inductor inductively coupled to the first and second series inductors and operable to produce a first filter response when the wireless circuitry is configured to operate in a first mode and a second filter response when the wireless circuitry is configured to operate in a second mode different than the first mode. The wireless circuitry can further include a switch coupled across the filter inductor, where the switch is deactivated in the first mode and is activated in the second mode, where the first mode exhibits a first passband at a first frequency, and where the second mode exhibits a second passband at a second frequency greater than the first frequency. The wireless circuitry can further include an additional filter inductor inductively coupled to the primary and secondary coils of the transformer and operable to produce the first filter response when the wireless circuitry is operable in the first mode and the second filter response when the wireless circuitry is operable in the second mode. The wireless circuitry can further include an additional switch coupled across the additional filter inductor, where the additional switch is activated in the first mode and is deactivated in the second mode.

An aspect of the disclosure provides wireless circuitry that includes first and second input transistors, a first cascode transistor coupled in series with the first input transistor, a second cascode transistor coupled in series with the second input transistor, a first resistor coupled to a gate terminal of the first cascode transistor, a second resistor coupled to a gate terminal of the second cascode transistor, and a first filter switch coupled across the first resistor. The first filter switch can be deactivated in a first mode and can be activated in a second mode. The first mode can exhibit a first passband at a first frequency, whereas the second mode can exhibit a second passband at a second frequency different than the first frequency. The wireless circuitry can further include a second filter switch coupled across the second resistor, where the second switch is deactivated in the first mode and is activated in the second mode. The wireless circuitry can further include a first capacitor cross-coupled with the first and second cascode transistors, a second capacitor cross-coupled with the first and second cascode transistors, a third filter switch coupled in series with the first capacitor, and a fourth filter switch coupled in series with the second capacitor, where the third and fourth filter switches are activated in the first mode and are deactivated in the second mode.

An aspect of the disclosure provides wireless circuitry that includes first and second input transistors, a first cascode transistor coupled in series with the first input transistor, a second cascode transistor coupled in series with the second input transistor, a first capacitor cross-coupled with the first and second cascode transistors, a second capacitor cross-coupled with the first and second cascode transistors, and a first filter switch coupled in series with the first capacitor. The first filter switch can be activated in a first mode and is deactivated in a second mode different than the first mode. The wireless circuitry can further include a second filter switch coupled in series with the second capacitor. The second filter switch can be activated in the first mode and can be deactivated in the second mode, where the first mode exhibits a first passband at a first frequency, and where the second mode exhibits a second passband at a second frequency greater than the first frequency.

### BRIEF DESCRIPTION OF THE DRAWINGS

FIG. 1 is a diagram of an illustrative electronic device having wireless circuitry in accordance with some embodiments.

FIG. 2 is a diagram of illustrative wireless circuitry that includes transceiver circuitry in accordance with some embodiments.

FIG. 3 is a diagram showing a spurious signal being relatively close to a passband in a first mode in accordance with some embodiments.

FIG. 4 is a diagram showing a spurious signal being relatively close to a passband in a second mode in accordance with some embodiments.

FIG. 5 is a diagram of a mixer coupled to illustrative transformer based filter circuitry operable in first and second modes in accordance with some embodiments.

FIG. 6 is a diagram of a passive filter in accordance with some embodiments.

FIG. 7 is a top (plan) view of the passive filter shown in FIG. 6 in accordance with some embodiments.

FIG. 8 is a diagram plotting transmission versus frequency for a filter of the type shown in FIGS. 6 and 7 in accordance with some embodiments.

FIG. 9 is a top (plan) view of a transformer based filter in accordance with some embodiments.

FIG. 10 is a diagram plotting transmission versus frequency for a filter of the type shown in FIG. 9 in accordance with some embodiments.

FIG. 11 is a circuit diagram of an illustrative active circuit having switchable cascode gate resistance in accordance with some embodiments.

FIG. 12 is a circuit diagram of an illustrative active circuit having switchable cascode cross-coupling capacitors in accordance with some embodiments.

FIG. 13 is a diagram plotting transmission versus frequency for wireless circuitry of the type shown in FIGS. 5-12 operating in a first mode in accordance with some embodiments.

FIG. 14 is a diagram plotting transmission versus frequency for wireless circuitry of the type shown in FIGS. 5-12 operating in a second mode in accordance with some embodiments.

### DETAILED DESCRIPTION

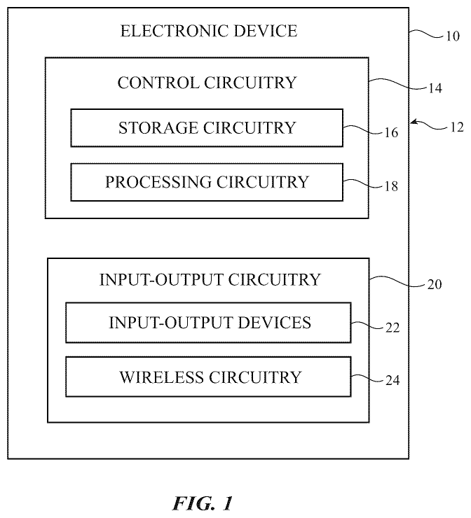

An electronic device such as electronic device 10 of FIG. 1 may be provided with wireless circuitry. The wireless circuitry may include one or more mixers such as a mixer in the transmit path for upconverting (modulating) signals from lower frequencies to higher frequencies and a mixer in the receive path for downconverting (demodulating) signals from higher frequencies to lower frequencies. A mixer can receive an oscillating (clock) signal from local oscillator circuitry. The local oscillator (LO) circuitry can exhibit non-linearities that produce spurious signals (or spurs). Such spurs can, if care if not taken, fall into a passband of interest during one or more operating modes of the wireless circuitry.

In accordance with some embodiments, the wireless circuitry can be provided with one or more filter circuits coupled to the output of a mixer. The filter circuits can be operable in a plurality of different modes (e.g., by activating and deactivating one or more associated switches) and can be configured to reject spurs at one or more frequencies, sometimes referred to herein as notch frequencies or null frequencies. These notch frequencies can be a function of a frequency of the oscillating signal from the LO circuitry, a function of an intermediate frequency between the higher radio-frequencies and baseband frequencies, and/or a function of other operating parameters. The mixer can be coupled to an active circuit (e.g., a radio-frequency circuit). The active circuit can optionally be provided with switchable cascode gate resistances. Additionally or alternatively, the active circuit can be provided with switchable cascode cross-coupling capacitors. Wireless circuitry configured in this way can be technically advantageous and beneficial for suppressing undesired spurious signals.

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed from plastic, glass, ceramics, fiber composites, metal (e.g., stainless steel, aluminum, metal alloys, etc.), other suitable materials, or a combination of these materials. In some embodiments, parts or all of housing 12 may be formed from dielectric or other low-conductivity material (e.g., glass, ceramic, plastic, sapphire, etc.). In other embodiments, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more microprocessors, microcontrollers, digital signal processors, host processors, baseband processor integrated circuits, application specific integrated circuits, central processing units (CPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 5G protocols, etc.), antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support wireless communications. Wireless circuitry 24 (sometimes referred to herein as wireless communications circuitry 24) may include one or more antennas. Wireless circuitry 24 may also include baseband processor circuitry, transceiver circuitry, amplifier circuitry, filter circuitry, switching circuitry, radio-frequency transmission lines, and/or any other circuitry for transmitting and/or receiving radio-frequency signals using the antenna(s).

Wireless circuitry 24 may transmit and/or receive radio-frequency signals within a corresponding frequency band at radio frequencies (sometimes referred to herein as a communications band or simply as a “band”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHZ), wireless personal area network (WPAN) frequency bands such as the 2.4 GHz Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands between 10-300 GHz, near-field communications frequency bands (e.g., at 13.56 MHZ), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

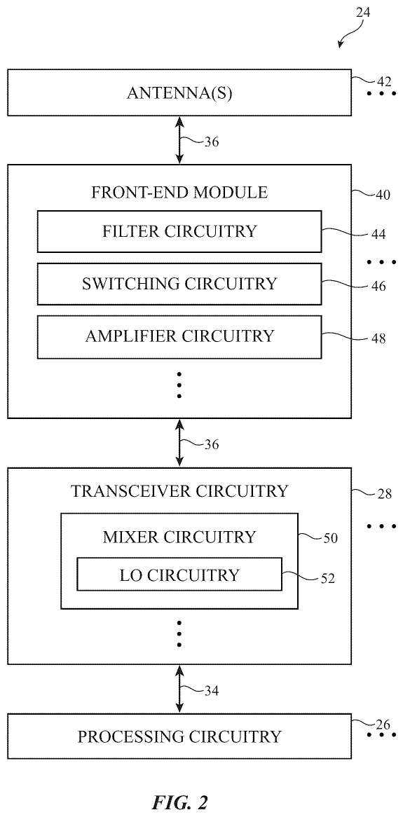

FIG. 2 is a diagram showing illustrative components within wireless circuitry 24. As shown in FIG. 2, wireless circuitry 24 may include one or more processors such as processing circuitry 26, radio-frequency (RF) transceiver circuitry such as radio-frequency transceiver 28, radio-frequency front end circuitry such as radio-frequency front end module (FEM) 40, and antenna(s) 42. Processing circuitry 26 may include a baseband processor, an application processor, a digital signal processor, a microcontroller, a microprocessor, a central processing unit (CPU), a programmable device, a combination of these circuits, and/or one or more processors within circuitry 18. Processing circuitry 26 may be configured to generate digital (transmit or baseband) signals. Processing circuitry 26 may be coupled to transceiver 28 over path 34 (sometimes referred to as a baseband path). Transceiver 28 may be coupled to antenna 42 via radio-frequency transmission line path 36. Radio-frequency front end module 40 may be disposed on radio-frequency transmission line path 36 between transceiver 28 and antenna 42.

Wireless circuitry 24 may include one or more antennas such as antenna 42. Antenna 42 may be formed using any desired antenna structures. For example, antenna 42 may be an antenna with a resonating element that is formed from loop antenna structures, patch antenna structures, inverted-F antenna structures, slot antenna structures, planar inverted-F antenna structures, helical antenna structures, monopole antennas, dipoles, hybrids of these designs, etc. Two or more antennas 42 may be arranged into one or more phased antenna arrays (e.g., for conveying radio-frequency signals at millimeter wave frequencies). Parasitic elements may be included in antenna 42 to adjust antenna performance. Antenna 42 may be provided with a conductive cavity that backs the antenna resonating element of antenna 42 (e.g., antenna 42 may be a cavity-backed antenna such as a cavity-backed slot antenna).

In the example of FIG. 2, wireless circuitry 24 is illustrated as including only a single processing circuitry 26, a single transceiver 28, a single front end module 40, and a single antenna 42 for the sake of clarity. In general, wireless circuitry 24 may include any desired number of processing circuitry 26, any desired number of transceivers 28, any desired number of front end modules 40, and any desired number of antennas 42. Processing circuitry 26 may be coupled to one or more transceiver 28 over respective paths 34. Each transceiver 28 may include a transmitter circuit configured to output uplink signals to antenna 42, may include a receiver circuit configured to receive downlink signals from antenna 42, and may be coupled to one or more antennas 42 over respective radio-frequency transmission line paths 36. Each radio-frequency transmission line path 36 may have a respective front end module 40 disposed thereon. If desired, two or more front end modules 40 may be disposed on the same radio-frequency transmission line path 36. If desired, one or more of the radio-frequency transmission line paths 36 in wireless circuitry 24 may be implemented without any front end module disposed thereon.

Front end module (FEM) 40 may include radio-frequency front end circuitry that operates on the radio-frequency signals conveyed (transmitted and/or received) over radio-frequency transmission line path 36. Front end module may, for example, include front end module (FEM) components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifiers and one or more low-noise amplifiers), impedance matching circuitry (e.g., circuitry that helps to match the impedance of antenna 42 to the impedance of radio-frequency transmission line 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front end module components may be mounted to a common (shared) substrate such as a rigid printed circuit board substrate or flexible printed circuit substrate. If desired, the various front end module components may also be integrated into a single integrated circuit chip.

Filter circuitry 44, switching circuitry 46, amplifier circuitry 48, and other circuitry may be disposed along radio-frequency transmission line path 36, may be incorporated into FEM 40, and/or may be incorporated into antenna 42 (e.g., to support antenna tuning, to support operation in desired frequency bands, etc.). These components, sometimes referred to herein as antenna tuning components, may be adjusted (e.g., using control circuitry 14) to adjust the frequency response and wireless performance of antenna 42 over time.

Radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path such that is coupled to the positive antenna feed terminal on antenna 42. Radio-frequency transmission line path 36 may have a ground transmission line signal path that is coupled to the ground antenna feed terminal on antenna 42. This example is illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include transmission lines that are used to route radio-frequency antenna signals within device 10 (FIG. 1). Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 36 may be integrated into rigid and/or flexible printed circuit boards. In one suitable arrangement, radio-frequency transmission line paths such as radio-frequency transmission line path 36 may also include transmission line conductors integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

Transceiver circuitry 28 may include wireless local area network transceiver circuitry that handles WLAN communications bands (e.g., Wi-Fi® (IEEE 802.11) or other WLAN communications bands) such as a 2.4 GHz WLAN band (e.g., from 2400 to 2480 MHZ), a 5 GHZ WLAN band (e.g., from 5180 to 5825 MHz), a Wi-Fi® 6E band (e.g., from 5925-7125 MHz), and/or other Wi-Fi® bands (e.g., from 1875-5160 MHZ), wireless personal area network transceiver circuitry that handles the 2.4 GHz Bluetooth® band or other WPAN communications bands, cellular telephone transceiver circuitry that handles cellular telephone bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), near-field communications (NFC) transceiver circuitry that handles near-field communications bands (e.g., at 13.56 MHZ), satellite navigation receiver circuitry that handles satellite navigation bands (e.g., a GPS band from 1565 to 1610 MHz, a Global Navigation Satellite System (GLONASS) band, a BeiDou Navigation Satellite System (BDS) band, etc.), ultra-wideband (UWB) transceiver circuitry that handles communications using the IEEE 802.15.4 protocol and/or other ultra-wideband communications protocols, and/or any other desired radio-frequency transceiver circuitry for covering any other desired communications bands of interest.

In performing wireless transmission, processing circuitry 26 may provide digital signals to transceiver 28 over path 34. Transceiver 28 may further include circuitry for converting the baseband signals received from processing circuitry 26 into corresponding intermediate frequency or radio-frequency signals. For example, transceiver circuitry 28 may include mixer circuitry 50 for up-converting (or modulating) the baseband signals to intermediate frequencies or radio frequencies prior to transmission over antenna 42. Transceiver circuitry 28 may also include digital-to-analog converter (DAC) and/or analog-to-digital converter (ADC) circuitry for converting signals between digital and analog domains. Transceiver 28 may include a transmitter component to transmit the radio-frequency signals over antenna 42 via radio-frequency transmission line path 36 and front end module 40. Antenna 42 may transmit the radio-frequency signals to external wireless equipment by radiating the radio-frequency signals into free space.

In performing wireless reception, antenna 42 may receive radio-frequency signals from external wireless equipment. The received radio-frequency signals may be conveyed to transceiver 28 via radio-frequency transmission line path 36 and front end module 40. Transceiver 28 may include circuitry for converting the received radio-frequency signals into corresponding intermediate frequency or baseband signals. For example, transceiver 28 may use mixer circuitry 50 for downconverting (or demodulating) the received radio-frequency signals to baseband frequencies prior to conveying the received signals to processing circuitry 26 over path 34. Mixer circuitry 50 can include local oscillator circuitry such as local oscillator (LO) circuitry 52. Local oscillator circuitry 52 can generate oscillator (oscillating) signals that mixer circuitry 50 uses to modulate transmitting signals from baseband frequencies to radio frequencies and/or to demodulate the received signals from radio frequencies to baseband frequencies.

In accordance with some embodiments, wireless circuitry 24 can be operable in a plurality of modes. Wireless circuitry 24 can be configured to operate in at least a first mode and a second mode. In the first mode, wireless circuitry 24 can be operated in a first frequency range (e.g., one or more first radio-frequency bands). In the second mode, wireless circuitry 24 can be operated in a second frequency range different than the first frequency range (e.g., in one or more second radio-frequency bands different than the first radio-frequency band(s)). For example, the first frequency range can be 37 GHz to 44 GHZ, whereas the second frequency range can be 47 GHz to 48 GHz. The first mode is thus sometimes referred to as a “mid-band” (MB) mode, whereas the second mode is sometimes referred to as a “high-band” (HB) mode. These frequency ranges are illustrative. In general, wireless circuitry 24 can be operable in three or more modes, four or more modes, or other suitable number of modes, each of which is associated with a different respective operating frequency range.

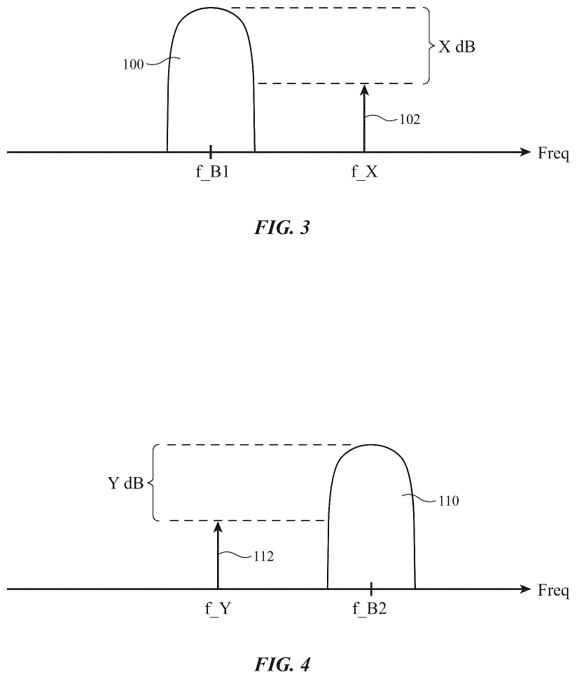

In certain applications, the oscillating signal output from LO circuitry 52 can generate a spurious signal that might impact the frequency range of interest. FIG. 3 is a diagram showing a spurious signal being relatively close to a passband of the first (mid-band) mode. As shown in FIG. 3, signals in the first mode should be conveyed in a passband 100 centered around frequency f_B1. In such scenarios, a corresponding oscillating signal output from circuitry 52, sometimes referred to herein as the “LO signal,” can produce an interference signal at frequency f_X (scc, e.g., a 2^{nd} harmonic LO spurious signal 102). If care is not taken, spurious signal 102 can be relatively close to passband 100 around frequency f_B1. Certain wireless specifications may require rejection of such spurious signals 102 by an amount X (in units of dB). In other words, spurious signal 102 should be attenuated relative to the passband (in-band) signals 100 by X dB.

FIG. 4 is a diagram showing a spurious signal being relatively close to a passband of the second (high-band) mode. As shown in FIG. 4, signals in the second mode should be conveyed in a passband 110 centered around frequency f_B2. In such scenarios, the LO signal can produce an interference signal at frequency f_Y (see, e.g., spurious signal 112) that is relatively close to passband 110 around frequency f_B2. Certain wireless specifications may require rejection of such spurious signals 112 by an amount Y (in units of dB). In other words, spurious signal 112 should be attenuated relative to the passband (in-band) signals 110 by Y dB.

The examples of FIGS. 3 and 4 in which spurious signals at frequency f_X could interfere with the passband signals around f_B1 during the first mode and in which spurious signals at frequency f_Y could interfere with the passband signals around f_B2 during the second mode are illustrative. In general, during one or more mode of operation or during any mode of operation of wireless circuitry 24, one or more spurious signals at the frequency higher than the passband or at a frequency lower than the passband may need to be attenuated or rejected.

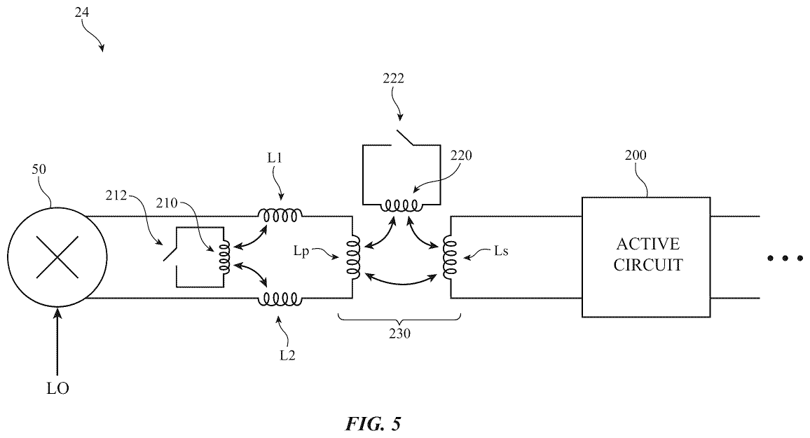

In accordance with an embodiment, the rejection or attenuation of such spurious signals can be provided using one or more filter circuits optionally coupled to a mixer. FIG. 5 is a diagram of a mixer 50 coupled to illustrative filter circuitry operable in at least the first and second modes in accordance with some embodiments. The filter circuitry can be configured to reject spurious signals at one or more frequencies, sometimes referred to herein as notch frequencies or null frequencies. The notch frequency can be a function of an LO frequency (e.g., a frequency of the LO signal). For example, the filter circuitry can be configured to provide the desired amount of signal rejection at the LO frequency, at two times the LO frequency (e.g., a 2nd harmonic LO frequency), at other multiples/harmonics of the LO frequency, at a frequency equal to the difference between the LO frequency and an intermediate frequency (e.g., a frequency between a baseband frequency and a radio-frequency to which a signal can be shifted as an intermediate step during modulation or demodulation), at a frequency equal to two times the LO frequency minus the intermediate frequency, at a frequency that is some function of the LO frequency and the intermediate frequency, etc. These notch frequencies that are a function of the LO frequency are illustrative. The filter circuitry can provide signal rejection/attenuation at one or more notch frequencies that are not a function of the LO frequency. In general, the filter circuitry can be configured to provide one or more stable and programmable notch frequencies. The rejection provided by the filter circuitry should be stable and robust over process variations (i.e., the amount of rejection remains greater than a desired level over variation in-built in the process).

As shown in FIG. 5, a mixer 50 can have an input configured to receive an oscillating signal LO (e.g., a signal generated by LO circuitry 52 in FIG. 2) and can have an output coupled to an active circuit such as active circuit 200 via a transformer 230. Active circuit 200 can be an amplifier, a radio-frequency amplifier, a variable gain amplifier (VGA), a phase shift circuit, one or more circuits in a transmit path, one or more circuits in a receive path, or other types of active circuit components. Transformer 230 may include a first (primary) coil Lp and a second (secondary) coil Ls. Primary coil (winding) Lp can have a first terminal coupled to an output of mixer 50 via inductor L1 and a second terminal coupled to the output of mixer 50 via inductor L2. Secondary coil (winding) Ls can have first and second terminals coupled to an input of active circuit 200.

Series inductors L1 and L2 can be inductively coupled to an inductor 210. Inductor 210 can have two terminals that are selectively shorted via a switch 212. The term “activate” with respect to a switch (or transistor) may refer to or be defined herein as an action that places the switch in an “on” or low-impedance state such that the two terminals of the switch are electrically connected to conduct current. Activating a switch can sometimes be referred to as turning on or closing a switch. The term “deactivate” with respect to a switch (or transistor) may refer to or be defined herein as an action that places the switch in an “off” or high-impedance state such that the two terminals of the switch/transistor are electrically disconnected with minimal leakage current. Deactivating a switch can sometimes be referred to as turning off or opening a switch.

When switch 212 is activated, the two opposing terminals of inductor 210 can be shorted together. When switch 212 is deactivated, the two opposing terminals of inductor 210 can be disconnected. Switch 212 can be deactivated during the first (mid-band) mode and activated during the second (high-band) mode. Inductor 210 being inductively coupled to the series inductors L1 and L2 can form part of a passive mid-band filter. As a result, inductor 210 is sometimes referred to herein as a “filter inductor” or “filter coil.”

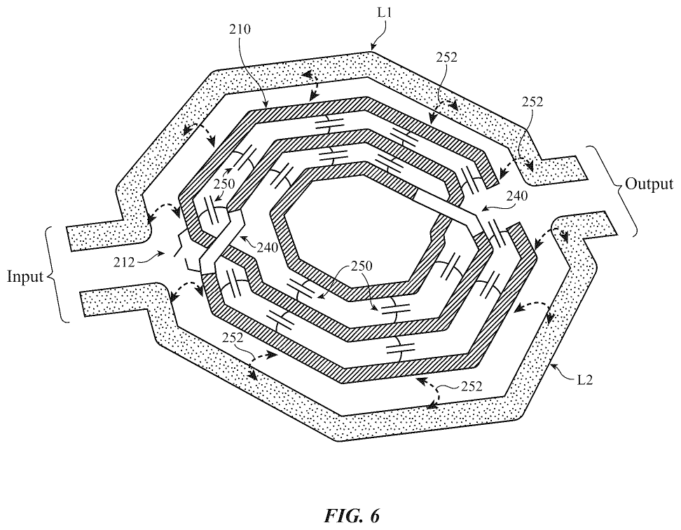

FIG. 6 is a diagram of the passive (mid-band) filter that includes inductors L1, L2, and 210. As shown in FIG. 6, inductor L1 may be implemented as a half-turn coil (winding) having a first distal end terminating at an input of the filter and a second distal end terminating at an output of the filter. Similarly, inductor L2 may be implemented as a half-turn coil (winding) having a first distal end terminating at the input of the filter and a second distal end terminating at the output of the filter. Coil L1 may be symmetrical or mirrored with respect to coil L2. Inductor 210 may be implemented as a multi-turn coil (winding) that is inductively coupled to inductors L1 and L2, as illustrated by arrows 252. The multiple turns (or windings) of coil 210 results in distributed capacitance 250, which produces a self-resonance with the inductance of coil 210 (e.g., coil 210 is configured to exhibit a self-resonance that is based on distributed capacitance 250). Coil 210 can have one or more cross-over paths 240. As shown in FIG. 6, a first portion of the windings of coil 210 can be selectively coupled to a second portion of the windings via switch 212. The filter of FIG. 6 is sometimes referred to as a passive coil based filter.

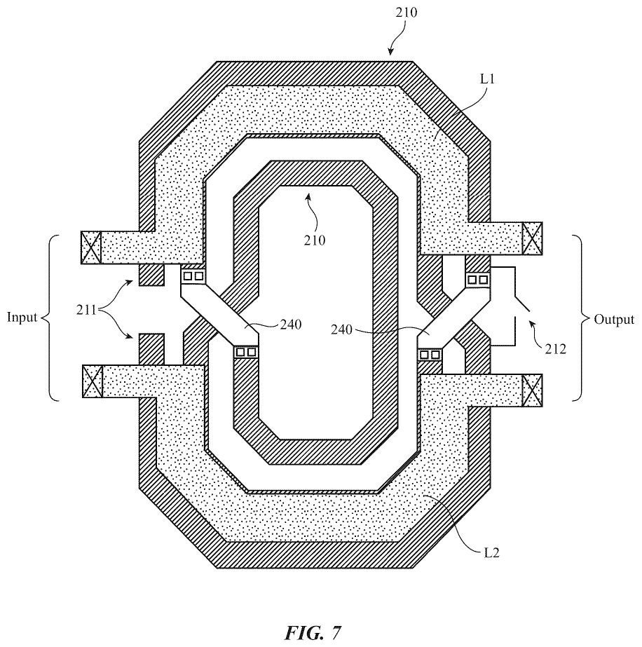

FIG. 7 is a top (plan) view of the filter shown in FIG. 6. As shown in FIG. 7, coil 210 can have three turns of windings coupled together via one or more cross-over paths 240. Coil 210 may have first and second portions that are selectively shorted together via switch 212. Coil 210 can have distal terminals 211 facing one another that are also disconnected from each other. Thus, coil 210 can be referred to as an “open-ended” inductor. Inductor L1 may overlap (e.g., disposed directly over or under) a first portion or half of coil 210, whereas inductor L2 may overlap (e.g., disposed directly over or under) a second portion or half of coil 210. The example of FIGS. 6 and 7 in which coil 210 includes three turns is illustrative. In other embodiments, coil 210 can include two or more turns, three or more turns, four or more turns, etc. Since coil 210 is coupled to inductors L1 and L2, energy is coupled from inductors L1 and L2 into coil 210 at the self-resonance frequency of coil 210 as determined by its distributed self-capacitance and self-inductance, thereby producing a signal transmission notch at this frequency.

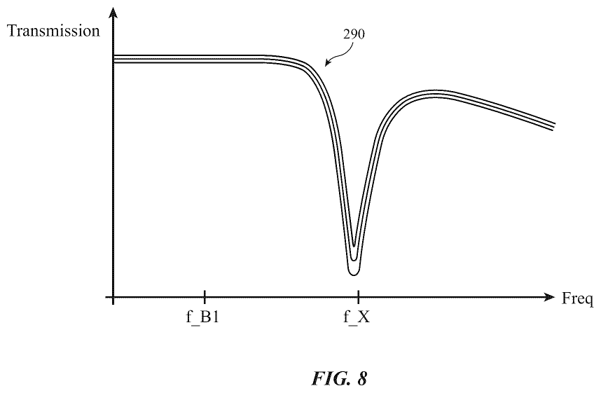

The passive filter of the type described in connection with FIGS. 6 and 7 can have an illustrative transmission response as shown in FIG. 8. FIG. 8 shows multiple filter responses 290 having high transmission at mid-band frequency f_B1 and low transmission at frequency f_X (see also FIG. 3). Operated in this way, the mid-band filter can be configured to reject undesired spurs at frequency f_X. As an example frequency f_X can be equal to two times the LO frequency. This is merely illustrative. In general, frequency f_X can represent any programmable notch frequency greater than or less than f_B1. The rejection frequency f_X can be equal to the self-resonance frequency of coil 210 (e.g., the passive filter can have a rejection band tuned by the inductance and distributed capacitance of coil 210). A passive filter implemented in this way is technically advantageous and beneficial since it exhibits a stable filter response that does not change with process variations.

In contrast, a conventional passive filter having a coil implemented as a single turn inductor terminated by a metal-oxide-metal (MOM) capacitor will exhibit a notch frequency that changes quite a lot with process variations. This is because the traditional MOM capacitor normally consists of many interdigitated metal fingers which are made up of metals layers provided at the bottom of the metal stack in a foundry process that are narrow and thin. Therefore, any process variation arising from the lithographic variations in processing these narrow and thin metal layers can lead to a larger percentage change in the value of the MOM capacitance. However, when the capacitance is realized by the distributed nature of the winding of coil 210, then it is more stable over process. This is because normally the inductors such as coil 210 are realized using special top metal layers. These top metal layers are much thicker and wider to provide a lower loss. Note that the absolute lithographic variation in processing these wider and thicker top metal layers is the same as the one in processing the narrower and thinner metal layers. Thus, the percentage change in capacitance realized using the wider and thicker top metal layer is also smaller. Hence, the filter characteristics, where the notch frequency is equal to the self-resonance frequency of the coil, also shows a smaller percentage change as compared to using a single-turn inductor and a MOM capacitor.

The switch 212 offers programmability in the position of the notch frequency. When switch 212 is deactivated, the inductance of all the turns of coil 210 self-resonates with the distributed capacitance of coil 210. However, when switch 212 is activated, it shorts outs the inner turns of coil 210. This reduces the inductance and capacitance of coil 210, making the self-resonance and thus the notch frequency much higher. This programmability is useful when the notch frequency in one mode (e.g., the MB mode) lies close to the passband of another mode (e.g., the HB mode). Hence, switch 212 can be deactivated in one mode (e.g., the MB mode) and activated in the other mode (e.g., the HB mode).

Referring back to FIG. 5, coils Lp and Ls of transformer 230 can be inductively coupled to an inductor 220. Inductor 220 can have two terminals that are selectively shorted via a switch 222. When switch 222 is activated, the two opposing terminals of inductor 220 can be shorted together. When switch 222 is deactivated, the two opposing terminals of inductor 220 can be disconnected. Switch 222 can be activated during the first (mid-band) mode and deactivated during the second (high-band) mode. Inductor 220 being inductively coupled to the transformer coils Lp and Ls can form part of a passive transformer based high-band filter. As a result, inductor 220 is sometimes referred to herein as a “filter inductor.”

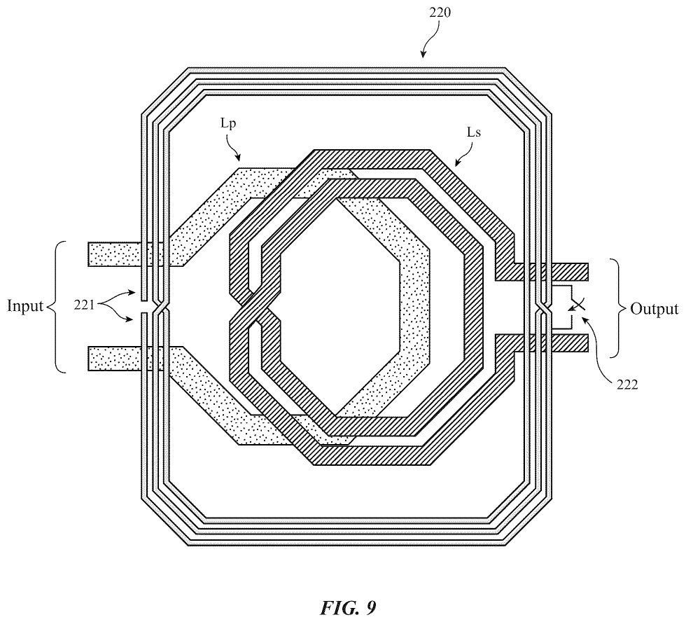

FIG. 9 is a top (plan) view of a transformer based filter formed from inductors Lp, Ls, and 220. As shown in FIG. 9, inductor Lp may be a single-turn coil having opposing terminals coupled to an input of the transformer. If desired, primary coil Lp can have one or more turns (windings). Inductor Ls may be a multi-turn coil having opposing terminals coupled to an output of the transformer. In general, secondary coil Ls can have one or more turns (windings). Inductor 220 may be implemented as a multi-turn coil (windings) coupled together via one or more cross-over paths and that at least partially surrounds coils Lp and Ls. In the example of FIG. 9, inductor 220 surrounds both coils Lp and Ls (when viewed in the layout or birds eye orientation of FIG. 9). Arranged in this way, coil 220 is inductively coupled to coils Lp and Ls in a symmetrical manner. Coil 220 can have two terminals that are selectively shorted via a switch 222. Coil 220 can be terminated with an open circuit, so coil 220 does not require any extra circuit components, thus minimizing circuit area. Coil 220 has distal terminals 221 facing one another but are disconnected from each other. Thus, coil 220 can be referred to as an “open-ended” inductor. The filter of FIG. 9 is sometimes referred to as a passive transformer based filter. The example of FIG. 9 in which coil 220 includes three turns is illustrative. In other embodiments, coil 220 can include two or more turns, three or more turns, four or more turns, etc.

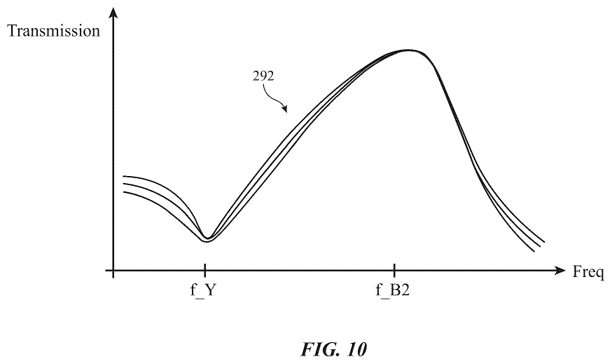

The passive transformer-based filter of the type described in connection with FIG. 9 can have an illustrative transmission response as shown in FIG. 10. FIG. 10 shows multiple filter responses 292 having high transmission at high-band frequency f_B2 and low transmission at frequency f_Y (see also FIG. 4). Operated in this way, the high-band filter can be configured to reject undesired spurs at frequency f_Y. As an example frequency f_Y can be equal to the fundamental LO frequency. This is merely illustrative. In general, frequency f_Y can represent any programmable notch frequency greater than or less than f_B2. As described above, energy can be coupled from inductors Lp and Ls to coil 220 at the self-resonance frequency f_Y, which is determined by its self-inductance and its distributed self-winding capacitance. This leads to a transmission null at frequency f_Y. For the reasons mentioned above, a passive filter implemented in this way is technically advantageous and beneficial since it exhibits a stable filter response that does not change with process variations as compared to one in which coil 220 is realized using a single-turn inductor and a MOM capacitor. As described above, the transmission null frequency is programmable by activating or deactivating the switch 222. Deactivating switch 222 allows the inductance of coil 220 to self-resonate with its distributed capacitance. Conversely, activating switch 222 results in shorting the coil's inner turns, which decreases both its inductance and capacitance, thereby raising the self-resonance frequency and consequently the notch frequency. This feature is particularly advantageous when the notch frequency in one operating mode, such as the HB (high-band) mode, is proximate to the passband of another mode, such as the MB (mid-band) mode. Therefore, switch 222 can be strategically deactivated in the HB mode and activated in the MB mode to optimize performance.

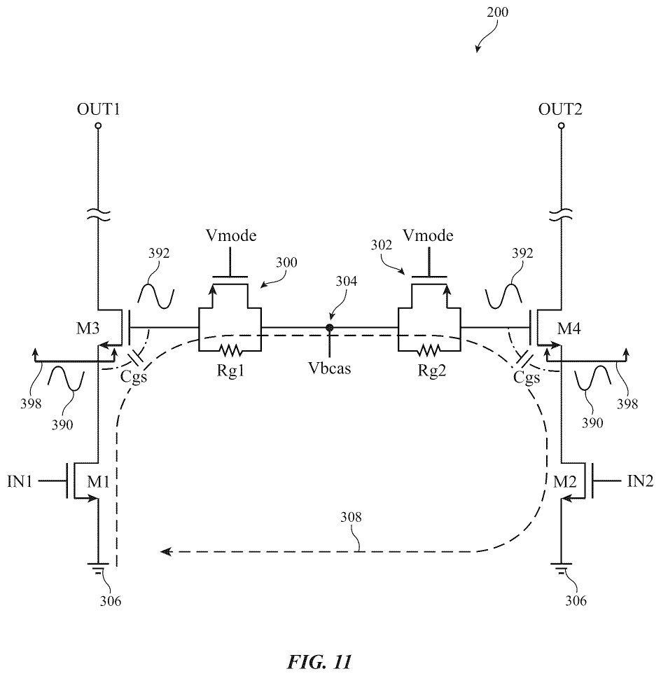

The embodiments described in connection with FIGS. 5-10 in which the rejection of undesired LO spurs is implemented using passive filter circuitry are exemplary. FIG. 11 shows another embodiment in which the filtering of undesired spurious signals is implemented using a switchable cascode gate resistance in accordance with an embodiment that is not mutually exclusive with the aforementioned embodiments. FIG. 11 is a circuit diagram of an active circuit 200 that can be coupled to mixer 50 (see, e.g., FIG. 5). As shown in FIG. 11, active circuit can include input transistors M1 and M2, cascode transistors M3 and M4, filter switches (transistors) 300 and 302, and gate resistors Rg1 and Rg2. Transistors M1-M4 can, for example, be implemented as n-type transistors (e.g., n-channel metal-oxide-semiconductor or NMOS transistors). The filter switches 300 and 302 can, for instance, be implemented as p-type (e.g., p-channel metal-oxide-semiconductor or PMOS transistors).

The first input transistor M1 can have a gate terminal coupled to a first input terminal IN1 of active circuit 200, a drain terminal, and a source terminal that is coupled to a ground power supply line 306 (e.g., a ground line on which a ground power supply voltage is provided). The second input transistor M2 can have a gate terminal coupled to a second input terminal IN2 of active circuit 200, a drain terminal, and a source terminal that is coupled to ground 306. The terms “source” and “drain” are sometimes used interchangeably when referring to current-conducting terminals of a metal-oxide-semiconductor transistor. The source and drain terminals are therefore sometimes referred to as “source-drain” terminals (e.g., a transistor has a gate terminal, a first source-drain terminal, and a second source-drain terminal).

The first cascode transistor M3 can be coupled in series with first input transistor M1. First cascode transistor M3 can have a first source-drain terminal coupled to the drain terminal of transistor M1, a second source-drain terminal coupled to a first output terminal OUT1 of circuit 200, and a gate terminal. The second cascode transistor M4 can be coupled in series with second input transistor M2. Second cascode transistor M4 can have a first source-drain terminal coupled to the drain terminal of transistor M2, a second source-drain terminal coupled to a second output terminal OUT2 of circuit 200, and a gate terminal.

The gate terminal of first cascode transistor M3 may be coupled to first gate resistor Rg1. Gate resistor Rg1 has a first terminal coupled to the gate terminal of transistor M3 and a second terminal coupled to a bias node 304 (e.g., a biasing node on which cascode bias voltage Vbcas is provided). The first filter switch 300 can be coupled in parallel with gate resistor Rg1 and can be selectively activated by control signal Vmode. Similarly, the gate terminal of second cascode transistor M4 may be coupled to second gate resistor Rg2. Gate resistor Rg2 has a first terminal coupled to the gate terminal of transistor M4 and a second terminal coupled to bias node 304. The second filter switch 302 can be coupled in parallel with gate resistor Rg2 and can also be selectively activated by control signal Vmode.

Control signal Vmode can be deasserted during the first (mid-band) mode to deactivate switches 300 and 302 and can be asserted during the second (high-band) mode to activate switches 300 and 302. Arranged in this way, the gate resistors Rg1 and Rg2 and the parasitic gate-to-source capacitance Cgs of the cascode transistors M3 and M4 form a high-pass filter. This allows a voltage to develop on the cascode gate node (see, e.g., voltage waveforms 392 at the gate terminals of cascode transistors M3 and M4), which in in-phase with a voltage at the cascode source node (see, e.g., voltage waveforms 390 at the source terminals of cascode transistors M3 and M4) at high frequencies. This results in a high impedance looking into the source terminals of the cascode transistors M3 and M4 at high frequencies, as shown by arrows 398. A high-pass filter implemented in this way can provide the desired signal attenuation at programmable notch frequency f_X during the first (mid-band) mode. For instance, any undesired high-frequency signal leaking into the source terminal of the cascode transistors can flow into the path taken by high frequency current as indicated by dotted path 308 (e.g., a high-frequency current path when switches 300 and 302 are deactivated in the first mode), thus preventing undesired spurious signals from flowing into the output terminals. On the other hand, the control signal Vmode can be asserted during the second (high-band) mode to short out the resistors Rg1 and Rg2, thus disabling the filtering of the higher frequencies in this mode.

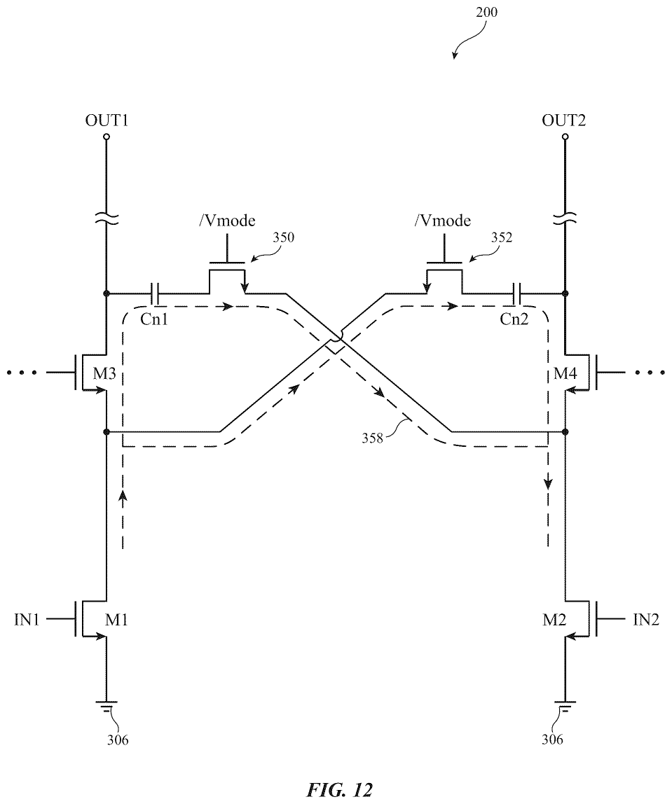

The embodiment of FIG. 11 in which the gate terminals of the cascode transistors M3 and M4 are coupled to associated gate resistors and filter switches is exemplary. FIG. 12 is a circuit diagram of another embodiment of active circuit 200 that is not mutually exclusive with the aforementioned embodiments. As shown in FIG. 12, active circuit 200 can further include cross-coupled capacitors Cn1 and Cn2 and filter switches (transistors) 350 and 352. The filter switches 350 and 352 can be implemented as NMOS transistors (as shown in the example of FIG. 12) or can alternatively be PMOS transistors. Capacitor Cn1 can have a first terminal coupled to the drain terminal of cascode transistor M3 and a second terminal coupled to the source terminal of cascode transistor M4 via transistor 350. Transistor 350 can be selectively activated by an inverted version of control signal Vmode (see inverted signal/Vmode). Capacitor Cn2 can have a first terminal coupled to the drain terminal of cascode transistor M4 and a second terminal coupled to the source terminal of cascode transistor M3 via transistor 352. Transistor 352 can be selectively activated by signal/Vmode). Capacitors Cn1 and Cn2 arranged in this way can refer to and be defined herein as “cross-coupled” capacitors.

Configured in this way, switches 350 and 352 can be activated during the first (mid-band) mode. On the other hand, switches 350 and 352 are deactivated during the second (high-band) mode and the intentional filtering of high-frequency signals is disabled in this mode. In this mode, any undesired high-frequency signal leaking into the source terminal of the cascode transistors can flow into the high-frequency cross-coupling path as indicated by dotted path 358 (e.g., a high-frequency current path when switches 350 and 352 are deactivated in the second mode), thus preventing undesired spurious signals from flowing into the output terminals.

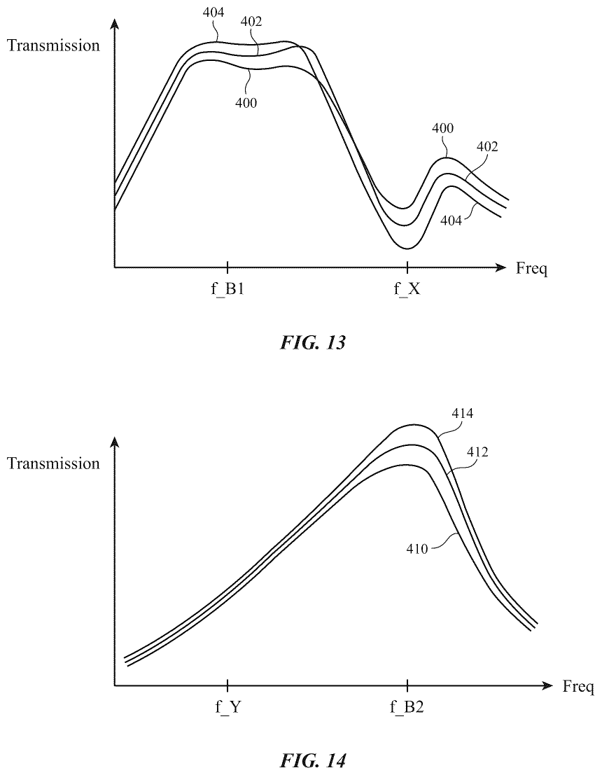

FIG. 13 is a diagram plotting transmission versus frequency for wireless circuitry 24 operating in the first (mid-band) mode. FIG. 13 shows multiple filter responses 400, 402, and 404 having high transmission at mid-band frequency f_B1 and low transmission at notch frequency f_X (see also FIG. 3). Curve 400 may represent the filter response of wireless circuitry 24 employing only the passive coil based filter circuitry described in connection with FIGS. 5-10. Curve 402 may represent the filter response of wireless circuitry 24 employing the passive coil based filter circuitry described in connection with FIGS. 5-10 and also the cascode gate resistance filter described in connection with FIG. 11. Curve 404 may represent the filter response of wireless circuitry 24 employing the passive coil based filter circuitry described in connection with FIGS. 5-10, the cascode gate resistance filter described in connection with FIG. 11, and also the cross-coupling capacitance filter described in connection with FIG. 12. Thus, as shown in FIG. 13, the use of additional cascode related filters can help further improve the rejection at notch frequency f_X during the first (mid-band) mode.

FIG. 14 is a diagram plotting transmission versus frequency for wireless circuitry 24 operating in the second (high-band) mode. FIG. 14 shows multiple filter responses 410, 412, and 414 having high transmission at high-band frequency f_B2 and low transmission at programmable notch frequency f_Y (see also FIG. 4). Curve 410 may represent the filter response of wireless circuitry 24 employing only the passive coil based filter circuitry described in connection with FIGS. 5-10. Curve 412 may represent the filter response of wireless circuitry 24 employing the passive coil based filter circuitry described in connection with FIGS. 5-10 and also the cascode gate resistance filter described in connection with FIG. 11. Curve 414 may represent the filter response of wireless circuitry 24 employing the passive coil based filter circuitry described in connection with FIGS. 5-10, the cascode gate resistance filter described in connection with FIG. 11, and also the cross-coupling capacitance filter described in connection with FIG. 12. Thus, as shown in FIG. 14, the use of additional cascode related filters can help further improve the rejection at notch frequency f_Y during the second (high-band) mode.

The methods and operations described above in connection with FIGS. 1-14 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 and/or wireless communications circuitry 24 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry in wireless circuitry 24, processing circuitry 18 of FIG. 1, etc.). The processing circuitry may include microprocessors, application processors, digital signal processors, central processing units (CPUs), application-specific integrated circuits with processing circuitry, or other processing circuitry.

The foregoing is illustrative and various modifications can be made to the described embodiments. The foregoing embodiments may be implemented individually or in any combination.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. Wireless circuitry comprising:
a transformer having a primary coil and a secondary coil;
a first series inductor coupled to a first terminal of the primary coil;
a second series inductor coupled to a second terminal of the primary coil; and
a filter inductor inductively coupled to the first and second series inductors and operable to produce a first filter response when the wireless circuitry is configured to operate in a first mode and a second filter response when the wireless circuitry is configured to operate in a second mode different than the first mode.

2. The wireless circuitry of claim 1, further comprising:
a switch coupled across the filter inductor, wherein the switch is deactivated in the first mode and is activated in the second mode, wherein the first mode exhibits a first passband at a first frequency, and wherein the second mode exhibits a second passband at a second frequency greater than the first frequency.

3. The wireless circuitry of claim 1, wherein the filter inductor comprises multiple turns and has a first distal terminal and a second distal terminal disconnected from the first distal terminal.

4. The wireless circuitry of claim 3, wherein:
the first series inductor comprises a half turn overlapping a first portion of the filter inductor; and
the second series inductor comprises a half turn overlapping a second portion of the filter inductor.

5. The wireless circuitry of claim 3, wherein the filter inductor is configured to exhibit a self-resonance based on a distributed capacitance, and wherein the first filter response is based on the self-resonance.

6. The wireless circuitry of claim 1, further comprising:
an additional filter inductor inductively coupled to the primary and secondary coils of the transformer and operable to produce the first filter response when the wireless circuitry is operable in the first mode and the second filter response when the wireless circuitry is operable in the second mode.

7. The wireless circuitry of claim 6, further comprising:
a switch coupled across the additional filter inductor, wherein the switch is activated in the first mode and is deactivated in the second mode, wherein the first mode exhibits a first passband at a first frequency, and wherein the second mode exhibits a second passband at a second frequency greater than the first frequency.

8. The wireless circuitry of claim 7, wherein the additional filter inductor is configured to exhibit a self-resonance based on a distributed self-capacitance, and wherein the second filter response is based on the self-resonance.

9. The wireless circuitry of claim 6, wherein:
the primary coil comprises windings having one or more turns;
the secondary coil comprises windings having one or more turns;
the additional filter inductor comprises windings having a plurality of turns and surrounding the primary and secondary coils.

10. The wireless circuitry of claim 6, wherein the additional filter inductor comprises multiple turns and has a first distal terminal and a second distal terminal disconnected from the first distal terminal.

11. The wireless circuitry of claim 1, further comprising:
first and second input transistors coupled to the transformer;
a first cascode transistor coupled in series with the first input transistor;
a second cascode transistor coupled in series with the second input transistor;
a first resistor coupled to a gate terminal of the first cascode transistor; and
a second resistor coupled to a gate terminal of the second cascode transistor.

12. The wireless circuitry of claim 11, further comprising:
a first filter switch coupled across the first resistor; and
a second filter switch coupled across the second resistor, wherein the first and second filter switches are deactivated in the first mode and are activated in the second mode, wherein the first mode exhibits a first passband at a first frequency, and wherein the second mode exhibits a second passband at a second frequency greater than the first frequency.

13. The wireless circuitry of claim 1, further comprising:
first and second input transistors coupled to the transformer;
a first cascode transistor coupled in series with the first input transistor;
a second cascode transistor coupled in series with the second input transistor;
a first capacitor cross-coupled with the first and second cascode transistors; and
a second capacitor cross-coupled with the first and second cascode transistors.

14. The wireless circuitry of claim 13, further comprising:
a first filter switch coupled in series with the first capacitor; and
a second filter switch coupled in series with the second capacitor, wherein the first and second filter switches are activated in the first mode and are deactivated in the second mode, wherein the first mode exhibits a first passband at a first frequency, and wherein the second mode exhibits a second passband at a second frequency greater than the first frequency.

15. Wireless circuitry comprising:
first and second input transistors;
a first cascode transistor coupled in series with the first input transistor;
a second cascode transistor coupled in series with the second input transistor;
a first resistor coupled to a gate terminal of the first cascode transistor;
a second resistor coupled to a gate terminal of the second cascode transistor; and
a first filter switch coupled across the first resistor.

16. The wireless circuitry of claim 15, wherein:
the first filter switch is deactivated in a first mode and is activated in a second mode;
the first mode exhibits a first passband at a first frequency; and
the second mode exhibits a second passband at a second frequency different than the first frequency.

17. The wireless circuitry of claim 16, further comprising:
a second filter switch coupled across the second resistor, wherein the second switch is deactivated in the first mode and is activated in the second mode.

18. The wireless circuitry of claim 17, further comprising:
a first capacitor cross-coupled with the first and second cascode transistors;
a second capacitor cross-coupled with the first and second cascode transistors;
a third filter switch coupled in series with the first capacitor; and
a fourth filter switch coupled in series with the second capacitor, wherein the third and fourth filter switches are activated in the first mode and are deactivated in the second mode.

19. Wireless circuitry comprising:
first and second input transistors;
a first cascode transistor coupled in series with the first input transistor;
a second cascode transistor coupled in series with the second input transistor;
a first capacitor cross-coupled with the first and second cascode transistors;
a second capacitor cross-coupled with the first and second cascode transistors; and
a first filter switch coupled in series with the first capacitor, wherein the first filter switch is activated in a first mode and is deactivated in a second mode different than the first mode.

20. The wireless circuitry of claim 19, further comprising:
a second filter switch coupled in series with the second capacitor, wherein the second filter switch is activated in the first mode and is deactivated in the second mode, wherein the first mode exhibits a first passband at a first frequency, and wherein the second mode exhibits a second passband at a second frequency greater than the first frequency.
